(19) United States
(12) Patent Application Publication
(10) Pub. No.: US 2012/0062189 A1
(43) Pub. Date: Mar. 15, 2012

(54) Switching regulator and control circuit and control method thereof

(75) Inventors: Ting-Hung Wang, Taipei (TW); Chia-Jung Lee, Toufen Township (TW)

(73) Assignee: Richtek Technology Corporation, R.O.C

(21) Appl. No.: 12/928,539

(22) Filed: Dec. 14, 2010

(30) Foreign Application Priority Data
Sep. 15, 2010 (TW) 099131141

(51) Int. Cl. G05F 1/10

(52) U.S. Cl. 323/271

(57) ABSTRACT

The present invention discloses a switching regulator, and a control circuit and method for controlling a switching regulator. The switching regulator includes a power stage driven by a driver voltage outputted from a driver circuit. The present invention detects an input current to generate an input current detection signal, and adjusts an operation voltage supplied to the driver circuit according to the input current detection signal.

### BACKGROUND OF THE INVENTION

1. Field of Invention

The present invention relates to a switching regulator, and a control circuit and method for controlling a switching regulator. Particularly, it relates to such switching regulator, control circuit, and control method which adjust the level of a pulse width modulation (PWM) signal according to an input current.

2. Description of Related Art

FIG. 1 shows a schematic diagram of a prior art switching regulator. As shown in the figure, a PWM controller 11 outputs a PWM signal for controlling at least one power transistor in a power stage 12 through a driver circuit 15, to convert an input voltage Vin to an output voltage Vout. The driver circuit 15 outputs a driver signal whose high level is determined by the operation voltage Vd of the driver circuit 15. A feedback circuit 13 generates a feedback signal related to the output voltage, and inputs the feedback signal to the PWM controller 11 to generate the PWM signal. The power stage 12 may be a synchronous or asynchronous buck, boost, inverting or buck-boost converter as shown in FIGS. 2A-2J.

When a load circuit is in light load condition, i.e., the current required by the load circuit is low, if the power transistor still operates in a normal mode, it will result in higher power loss (including switching loss and conduction loss). Therefore, a prior art method is proposed which dynamically adjusts the gate driving voltage of the power transistor to reduce the power loss. More specifically, the prior art method detects an output current Iout to generate an output current detection signal, and inputs the output current detection signal to the PWM controller 11. When the output current Tout is relatively low, which means that the load circuit is in light load condition, the PWM controller 11 reduces the operation voltage Vd of the driver circuit 15, such that the power transistor in the power stage 12 operates according to the loading condition at the output terminal to reduce the power loss.

The aforementioned prior art which detects the output current and adjusts the operation voltage Vd of the driver circuit 15 accordingly is disclosed in, e.g., U.S. Pat. No. 7,265,601, U.S. Pat. No. 7,345,463, and U.S. Pat. No. 7,615,940.

However, when the switching regulator is a multi-phase switching regulator having multiple power stages and corresponding PWM controllers, it becomes very complicated to obtain the output current detection signal because there are multiple output current paths. In this case, it often requires a very large circuit area for multi-path output current detection, and the signal processing is also very complicated.

In view of the foregoing, the present invention provides a switching regulator, and a control circuit and method for controlling a switching regulator, which adjust the level of the PWM signal to optimize the operation of the power transistor by detecting the input current.

### SUMMARY OF THE INVENTION

The first objective of the present invention is to provide a switching regulator.

The second objective of the present invention is to provide a control circuit for controlling a switching regulator.

The third objective of the present invention is to provide a control method for controlling a switching regulator.

To achieve the objective mentioned above, from one perspective, the present invention provides a switching regulator, comprising: a driver circuit, for receiving a PWM signal and generating a driver signal, the driver circuit determining high level of the driver signal according to an operation voltage; a power stage, switching at least one power transistor to convert an input voltage to an output voltage according to the driver signal; an input current detection circuit, coupled between the power stage and the input voltage, for detecting an input current and generating an input current detection signal; a feedback circuit, generating a feedback signal according to the output voltage; and a PWM controller, generating the PWM signal according to the feedback signal, and adjusting the operation voltage according to the input current detection signal.

From another perspective, the present invention provides a switching regulator control circuit, for generating a PWM signal for switching at least one power transistor in a power stage through a driver circuit to convert an input voltage to an output voltage, wherein the driver circuit determines high level of a driver signal outputted from the driver circuit according to an operation voltage, the switching regulator control circuit comprising: an input current detection circuit, coupled between the power stage and the input voltage, for detecting an input current and generating an input current detection signal; and a PWM controller, generating the PWM signal according to a feedback signal related to the output voltage, and adjusting the operation voltage according to the input current detection signal.

In the aforementioned switching regulator or switching regulator control circuit, the PWM controller preferably includes: a PWM signal generator, coupled to the feedback circuit, for generating the PWM signal according to the feedback signal; and a driver voltage adjustment circuit, coupled to the input current detection circuit, for determining the operation voltage according to the input current detection signal.

The driver voltage adjustment circuit preferably includes a circuit which can provide more than two different voltages, such as a selection circuit, a linear regulator with adjustable reference voltage, or a variable multifold charge pump circuit with variable output to input voltage ratio.

The aforementioned switching regulator may be a multi-phase switching regulator.

From another perspective, the present invention provides a control method for controlling a switching regulator, the switching regulator switching at least one power transistor in a power stage according to a PWM signal by a driver circuit to convert an input voltage to an output voltage, and obtaining a feedback signal according to the output voltage, wherein the driver circuit determines high level of a driver signal outputted from the driver circuit according to an operation voltage, the control method comprising: generating an input current detection signal according to an input current; generating the PWM signal according to the feedback signal; and adjusting the operation voltage according to the input current detection signal.

In the aforementioned control method, the step of adjusting the operation voltage according to the input current detection signal preferably includes: comparing the input current detection signal with a reference voltage; and determining the operation voltage, or a reference voltage of a linear regulator circuit, or the output to input voltage ratio of a variable multifold charge pump circuit, according to the comparison result.

The objectives, technical details, features, and effects of the present invention will be better understood with regard to the detailed description of the embodiments below.

### BRIEF DESCRIPTION OF THE DRAWINGS

FIG. 1 shows a schematic diagram of a prior art switching regulator.

FIGS. 2A-2J show synchronous and asynchronous buck, boost, inverting and buck-boost converters.

FIG. 3 shows an embodiment of the basic structure of the present invention.

FIG. 4 shows another embodiment of the present invention.

FIG. 5 shows an embodiment of the present invention with more hardware details.

FIG. 6 illustrates the conversion efficiency of different input currents at two different driving voltages.

FIGS. 7 and 8 show two embodiments of the driver voltage adjustment circuit 112.

FIG. 9 shows an embodiment of a multi-phase switching regulator according to the present invention.

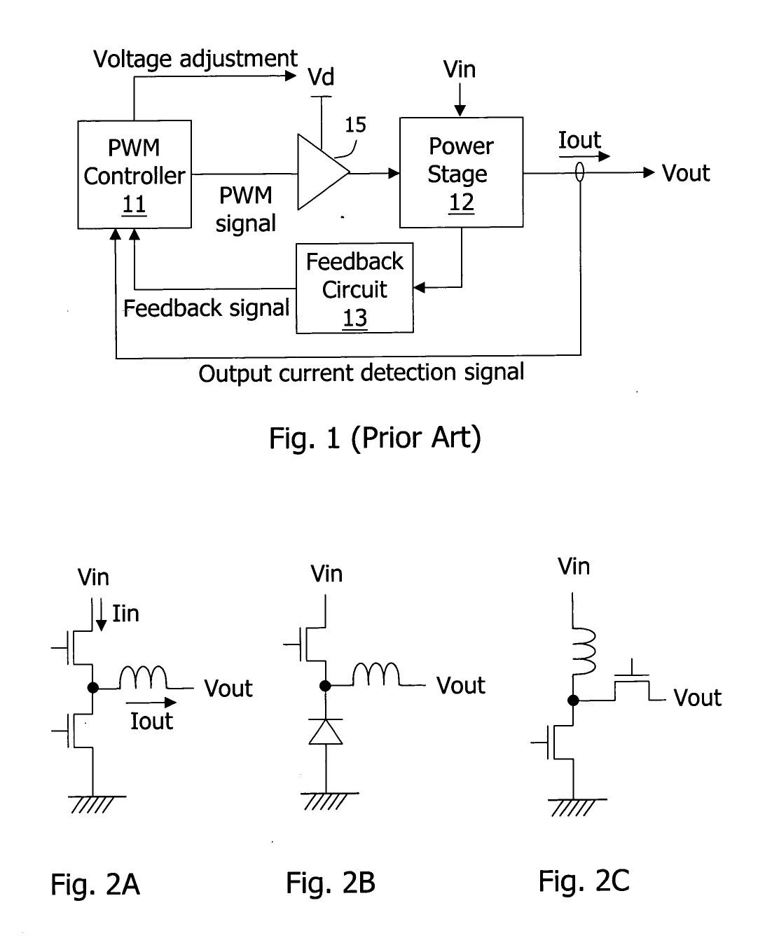

### DESCRIPTION OF THE PREFERRED EMBODIMENTS

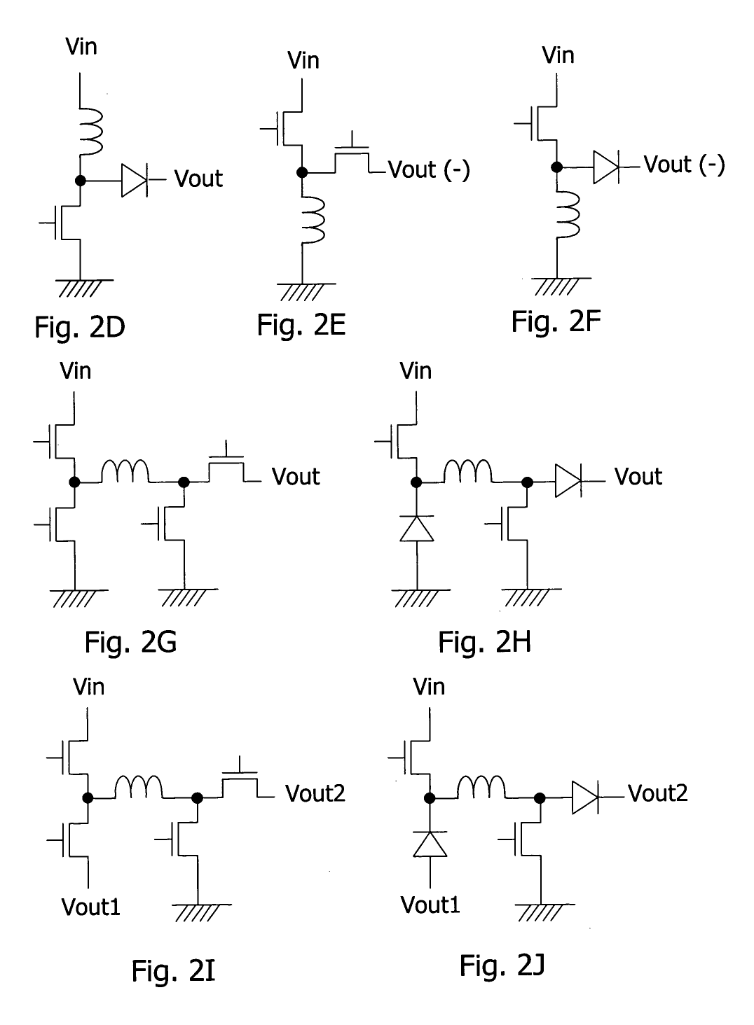

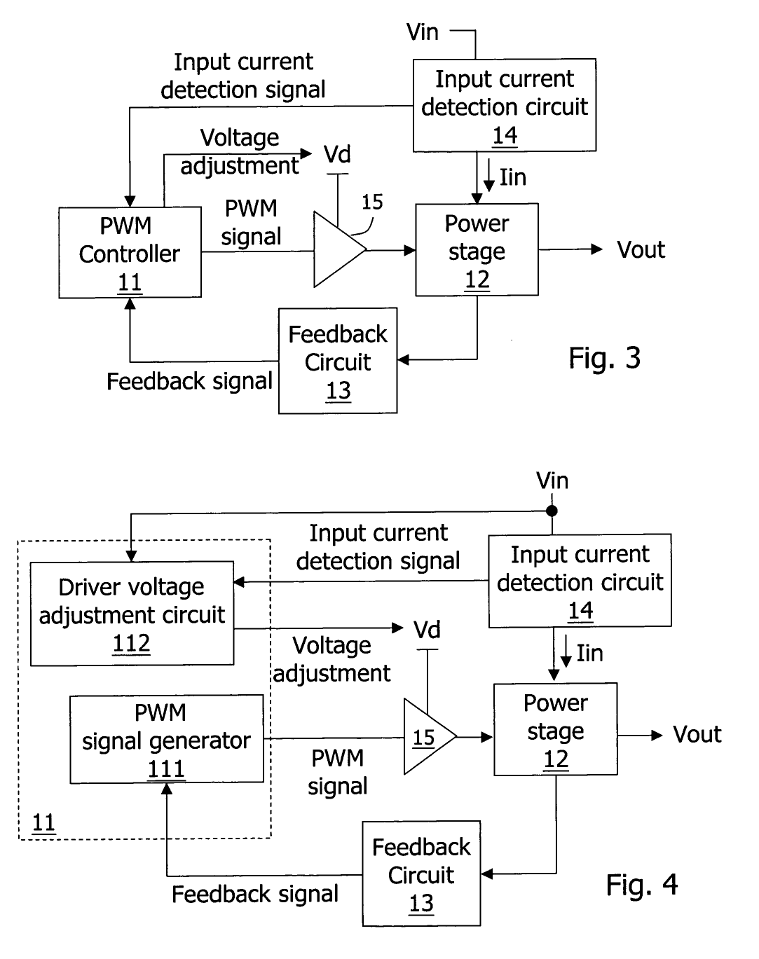

FIG. 3 shows an embodiment of the basic structure of the present invention. As shown in the figure, a PWM controller 11 outputs a PWM signal which controls at least one power transistor in a power stage 12 through a driver circuit 15, to convert an input voltage Vin to an output voltage Vout. The driver circuit 15 outputs a driver signal whose high level (i.e., the driving voltage of the power transistor) is determined by the operation voltage Vd of the driver circuit 15. A feedback circuit 13 generates a feedback signal related to the output voltage, and inputs the feedback signal to the PWM controller 11 to generate the PWM signal. The power stage 12 may be a synchronous or asynchronous buck, boost, inverting or buck-boost converter as shown in FIGS. 2A-2J. Different from the prior art, the switching regulator of the present invention detects an input current Iin by an input current detection circuit 14 to generate an input current detection signal, and inputs the input current detection signal to the PWM controller 11. The PWM controller 11 adjusts the operation voltage Vd of the driver circuit 15 according to the input current detection signal, such that the power transistor in the power stage 12 operates in an optimized condition to reduce power loss. When the load circuit is in light load condition, i.e., the output current is low, the input current Iin will correspondingly drop. Therefore by detecting the input current Iin, the present invention can dynamically adjust the operation voltage Vd to reduce the power loss. Furthermore, an advantage of the present invention over the prior art is that, the present invention can be embodied with a simpler hardware circuit in a multi-phase switching regulator.

FIG. 4 shows a more specific embodiment of the present invention. As shown in the figure, the PWM controller 11 includes a PWM signal generator 111, which is coupled to the feedback circuit 13, for generating the PWM signal according to the feedback signal and sending the PWM signal to the driver circuit 15; and a driver voltage adjustment circuit 112 which is coupled to the input current detection circuit 14, for dynamically adjusting the operation voltage Vd according to the input current detection signal. In this embodiment, the driver voltage adjustment circuit 112 receives the input voltage Vin and converts it to the operation voltage Vd, wherein the conversion ratio of the input voltage Vin to the operation voltage Vd is determined by the input current detection signal.

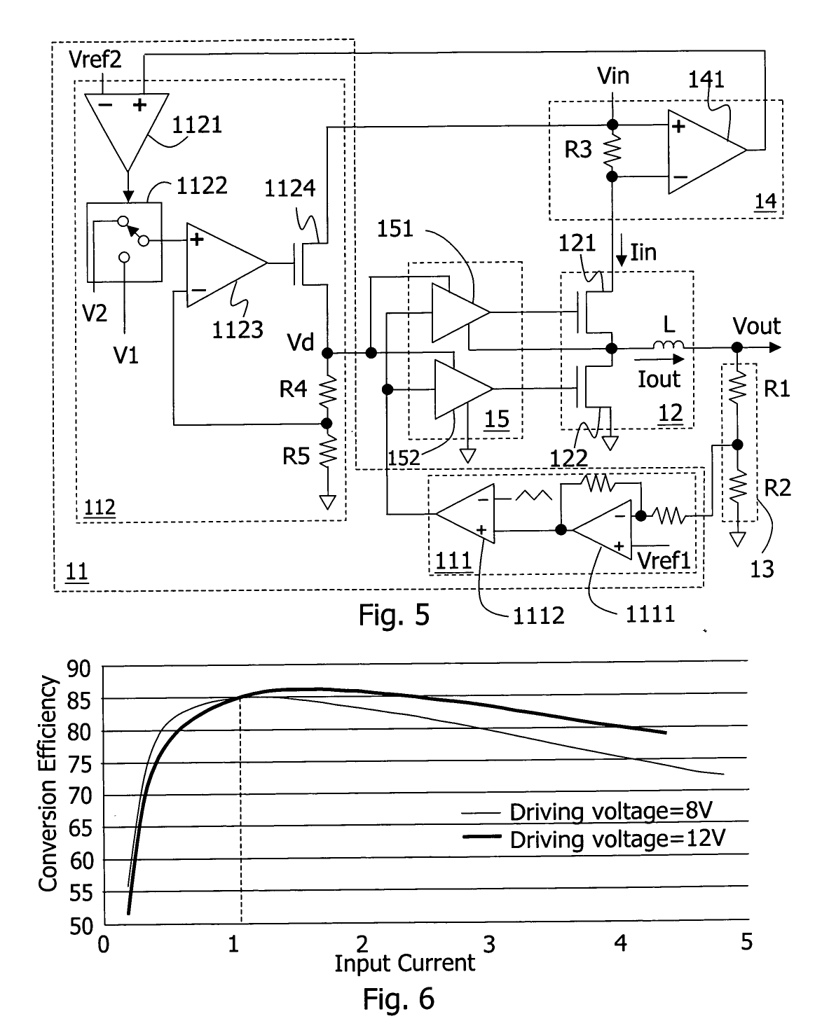

FIG. 5 shows another embodiment of the present invention, which illustrates more specific details. As shown in the figure, the power stage 12 is (for example but not limited to) a buck converter as shown in FIG. 2A, which includes an upper power transistor 121, a lower power transistor 122, and an inductor L. The correlation of the input power and the output power is:

Vin*Iin=Vout*Iout*η

Wherein η is the conversion efficiency. From the equation, it can be understood that the input current Iin also relates to the load, so the detection of the input current Iin can be used as a reference for adjusting the gate driving voltage of the power transistor to optimize the operation of the power transistor.

Still referring to FIG. 5, the feedback circuit 13 includes two resistors R1 and R2 connected in series. One end of the resistor R1 is coupled to the output voltage Vout, and one end of the resistor R2 is coupled to ground. In other words, the resistors R1 and R2 form a voltage dividend circuit which samples the output voltage Vout by the resistor R2. The input current detection circuit 14 includes a resistor R3 and an error amplifier 141, for detecting the input current Iin, and generating the input current detection signal.

The PWM controller 11 includes the PWM signal generator 111 and the driver voltage adjustment circuit 112. As shown in the figure, the PWM signal generator 111 includes an error amplifier 1111 and a comparator 1112. The error amplifier 1111 is coupled to the feedback circuit 13 to receive the feedback signal, and compares the feedback signal with a reference signal Vref1. The output of the error amplifier 1111 is inputted to the comparator 1112. The comparator 1112 receives the output from the error amplifier 1111, and compares it with a ramp signal to generate the PWM signal.

The driver voltage adjustment circuit 112 includes a comparator 1121, a selection circuit 1122, an error amplifier 1123, a transistor 1124, and resistors R4 and R5. In the driver voltage adjustment circuit 112, the error amplifier 1123, the transistor 1124, and the resistors R4 and R5 form a linear regulator which generates the operation voltage Vd and supplies it to the driver circuit 15. The comparator 1121 receives the input current detection signal from the input current detection circuit 14, and compares the input current detection signal with a reference signal Vref2. The comparison result of the comparator 1121 determines whether the selection circuit 1122 selects the voltage signal V1 or V2 as the reference signal to be inputted to the error amplifier 1123. The error amplifier 1123 controls the control terminal of the transistor 1124 according to the comparison between its two inputs, i.e., the voltage across the resistor R5 and the reference voltage V1 or V2, and generates different operation voltages Vd at the output terminal of the linear regulator as the reference voltages are different. The operation voltage Vd is inputted to an upper driver gate 151 and a lower driver gate 152 to drive the upper power transistor 121 and the lower power transistor 122. If the number of the power transistors in the power stage 12 is different (for example, an asynchronous buck convertor has only one power transistor), the number of the driver gates in the driver circuit 15 should be modified accordingly.

FIG. 6 illustrates the conversion efficiency of different input currents at different driving voltages. In this example, when the input current is lower than 1.1 A, if the driving voltage is switched from 12V to 8V, the conversion efficiency will be better. The present invention can achieve this.

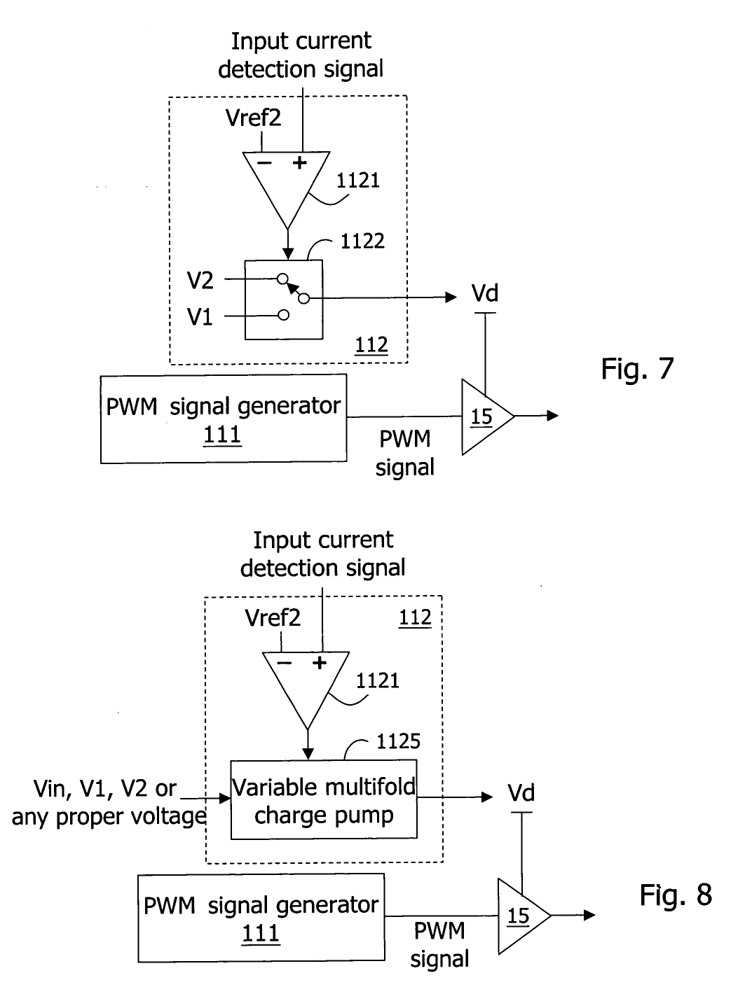

In the aforementioned embodiments, the reference voltage of the linear regulator is determined by the input current detection signal; the operation voltage Vd is the output of the linear regulator; and the regulator input voltage of the linear regulator is the input voltage Vin. However, the regulator input voltage of the linear regulator does not have to be the input voltage Vin, but can be any voltage instead. In fact, it suffices as long as the driver voltage adjustment circuit 112 can provide two different voltages as options for the operation voltage Vd, and the operation voltage Vd is switchable according to the input current detection signal. For example as shown in FIG. 7, the driver voltage adjustment circuit 112 may include the comparator 1121 and the selection circuit 1122 wherein the selection circuit 1122 determines whether the voltage V1 or V2 is provided as the operation voltage Vd according to the output of the comparator 1121. For another example, as shown in FIG. 8, the driver voltage adjustment circuit 112 may include the comparator 1121 and a variable multifold charge pump circuit 1125, wherein the selection circuit 1122 determines the output-to-input ratio of the variable multifold charge pump circuit 1125 according to the output of the comparator 1121 (the ratio of the charge pump output voltage to the charge pump input voltage does not have to be larger than 1, nor does it have to be an integer), and the output of the variable multifold charge pump circuit 1125 is provided as the operation voltage Vd. Those skilled in this art can readily conceive variations and modifications of the driver voltage adjustment circuit 112 within the spirit of the present invention, which should be interpreted to fall within the scope of the appended claims.

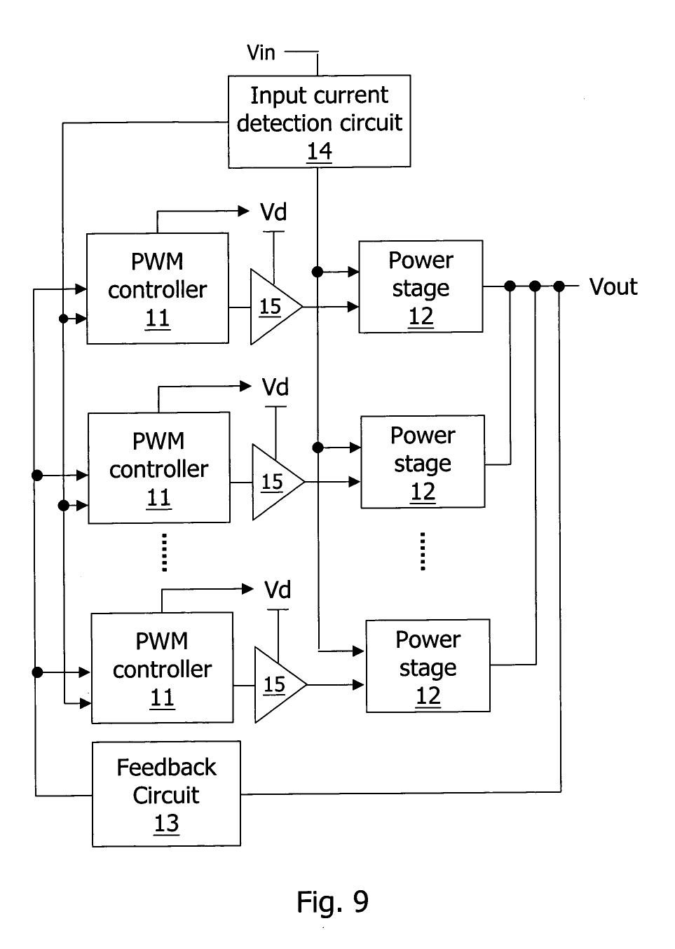

FIG. 9 shows an embodiment of a multi-phase switching regulator according to the present invention. As shown in the figure, the multi-phase switching regulator includes multiple PWM controllers 11 and multiple corresponding power stages 12. This embodiment shows that one input current detection signal generated by one input current detection circuit 14 is inputted to every PWM controller 11, that is, only one input current detection circuit 14 is enough. Compared to the prior art which needs multiple output current detection circuits, the present invention simplifies the circuit design and saves the circuitry area.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device which does not substantially influence the primary function of a signal can be inserted between any two devices in the shown embodiments, such as a switch or the like. For another example, the positive and negative input terminals of the error amplifiers or comparators are interchangeable, with corresponding amendment of the circuits processing these signals. In view of the foregoing, the spirit of the present invention should cover all such and other modifications and variations, which should be interpreted to fall within the scope of the following claims and their equivalents.

What is claimed is:

1. A switching regulator, comprising:
a driver circuit, for receiving a pulse width modulation (PWM) signal and generating a driver signal, the driver circuit determining high level of the driver signal according to an operation voltage;
a power stage, switching at least one power transistor to convert an input voltage to an output voltage according to the driver signal;
an input current detection circuit, coupled between the power stage and the input voltage, for detecting an input current and generating an input current detection signal;
a feedback circuit, generating a feedback signal according to the output voltage; and
a PWM controller, generating the PWM signal according to the feedback signal, and adjusting the operation voltage according to the input current detection signal.

2. The switching regulator of claim 1, wherein the PWM controller includes:
a PWM signal generator, coupled to the feedback circuit, for generating the PWM signal according to the feedback signal; and
a driver voltage adjustment circuit, coupled to the input current detection circuit, for determining the operation voltage according to the input current detection signal.

3. The switching regulator of claim 2, wherein the driver voltage adjustment circuit includes:
a comparator, comparing the input current detection signal with a reference voltage; and
a selection circuit, determining the operation voltage according to a comparison result of the comparator.

4. The switching regulator of claim 2, wherein the driver voltage adjustment circuit includes:
a comparator, comparing the input current detection signal with a first reference voltage;
a linear regulator circuit, for receiving a linear regulator input voltage, and converting the linear regulator input voltage to the operation voltage according to a second reference voltage; and
a selection circuit, determining the second reference voltage according to a comparison result of the comparator.

5. The switching regulator of claim 2, wherein the driver voltage adjustment circuit includes:
a comparator, comparing the input current detection signal with a reference voltage; and
a variable multifold charge pump circuit, for receiving a charge pump input voltage and generating a charge pump output voltage, wherein the ratio of the charge pump output voltage to the charge pump input voltage is determined by a comparison result of the comparator.

6. The switching regulator of claim 1, wherein the switching regulator is a multi-phase switching regulator including multiple driver circuits, and power stages.

7. A switching regulator control circuit, for generating a pulse width modulation (PWM) signal for switching at least one power transistor in a power stage through a driver circuit to convert an input voltage to an output voltage, wherein the driver circuit determines high level of a driver signal outputted from the driver circuit according to an operation voltage, the switching regulator control circuit comprising:
an input current detection circuit, coupled between the power stage and the input voltage, for detecting an input current and generating an input current detection signal; and
a PWM controller, generating the PWM signal according to a feedback signal related to the output voltage, and adjusting the operation voltage according to the input current detection signal.

8. The control circuit of claim 7, wherein the PWM controller includes:
a PWM signal generator, for generating the PWM signal according to the feedback signal; and
a driver voltage adjustment circuit, coupled to the input current detection circuit, for determining the operation voltage according to the input current detection signal.

9. The control circuit of claim 8, wherein the driver voltage adjustment circuit includes:
a comparator, comparing the input current detection signal with a reference voltage; and
a selection circuit, determining the operation voltage according to a comparison result of the comparator.

10. The control circuit of claim 8, wherein the driver voltage adjustment circuit includes:
a comparator, comparing the input current detection signal with a first reference voltage;
a linear regulator circuit, for receiving a linear regulator input voltage, and converting the linear regulator input voltage to the operation voltage according to a second reference voltage; and
a selection circuit, determining the second reference voltage according to a comparison result of the comparator.

11. The control circuit of claim 8, wherein the driver voltage adjustment circuit includes:
a comparator, comparing the input current detection signal with a reference voltage; and
a variable multifold charge pump circuit, for receiving a charge pump input voltage and generating a charge pump output voltage, wherein the ratio of the charge pump output voltage to the charge pump input voltage is determined by a comparison result of the comparator.

12. A control method for controlling a switching regulator, the switching regulator switching at least one power transistor in a power stage according to a pulse width modulation (PWM) signal by a driver circuit to convert an input voltage to an output voltage, and obtaining a feedback signal according to the output voltage, wherein the driver circuit determines high level of a driver signal outputted from the driver circuit according to an operation voltage, the control method comprising:
generating an input current detection signal according to an input current;
generating the PWM signal according to the feedback signal; and
adjusting the operation voltage according to the input current detection signal.

13. The control method of claim 12, wherein the step of adjusting the operation voltage according to the input current detection signal includes:
comparing the input current detection signal with a reference voltage; and
determining the operation voltage according to the comparison result.

14. The control method of claim 12, wherein the step of adjusting the operation voltage according to the input current detection signal includes:
providing a linear regulator circuit, for receiving a linear regulator input voltage, and converting the linear regulator input voltage to the operation voltage according to a first reference voltage; and
comparing the input current detection signal with a second reference voltage to determine the first reference voltage.

15. The control method of claim 12, wherein the step of adjusting the operation voltage according to the input current detection signal includes:
providing a variable multifold charge pump circuit, for receiving a charge pump input voltage and generating a charge pump output voltage; and
comparing the input current detection signal with a reference voltage to determine the ratio of the charge pump output voltage to the charge pump input voltage.
